(19) United States
(12) Patent Application Publication
(10) Pub. No.: US 2006/0274814 A1
(43) Pub. Date: Dec. 7, 2006

(54) Temperature-sensing device for a cooking pan

(76) Inventor: Chung-Che Wang, Tainan City (TW)

Correspondence Address: LEONG C LEI, PMB # 1008, 1867 YGNACIO VALLEY ROAD, WALNUT CREEK, CA, 94598, US

(21) Appl. No.: 11/142,298

(22) Filed: Jun. 2, 2005

(51) Int. Cl. G01K 1/00

(52) U.S. Cl. 374/208

(57) ABSTRACT

A temperature-sensing device for a cooking pan is disclosed. The device is clipped or fastened onto the circumferential edge of a cooking pan, and the temperature of the cooking pan causes the temperature-sensing device to change to a specific color to indicate the temperature of the cooking pan. This allows user to determine the temperature of the cooking pan or the like.

### BACKGROUND OF THE INVENTION

(a) Technical Field of the Invention

The present invention relates to temperature-sensing device, and in particular, a temperature-sensing device for a cooking pan to indicate the temperature of the pan.

(b) Description of the Prior Art

Taiwanese Patent Publication No. 545575 relates to a temperature-sensing device for food stirring in cooking. The device can determine the temperature of the cooking pan but the device has to be in contact with the cooked food in the heating or cooking pan. In addition, the device indicates the temperature of the food and does not show the appropriate temperature of the pan for which the temperature of the food stuff is to be placed into the pan.

Accordingly, it is an object of the present invention to provide a temperature-sensing device which can mitigate the drawback of the conventional temperature-sensing device.

### SUMMARY OF THE INVENTION

The primary purpose of the present invention is to provide a temperature-sensing device for a cooking pan having a clip made from heat conductive material mounted onto the circumferential edge of the cooking pan, characterized in that one end of the clip fastened at the circumferential edge turns to a color when the pan body is heated, allowing a user to determine the temperature of the cooking pan.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of the temperature-sensing device in accordance with the present invention

FIG. 2 is a sectional view of the present invention.

FIG. 3 is a schematic view showing the application of the temperature-sensing device of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

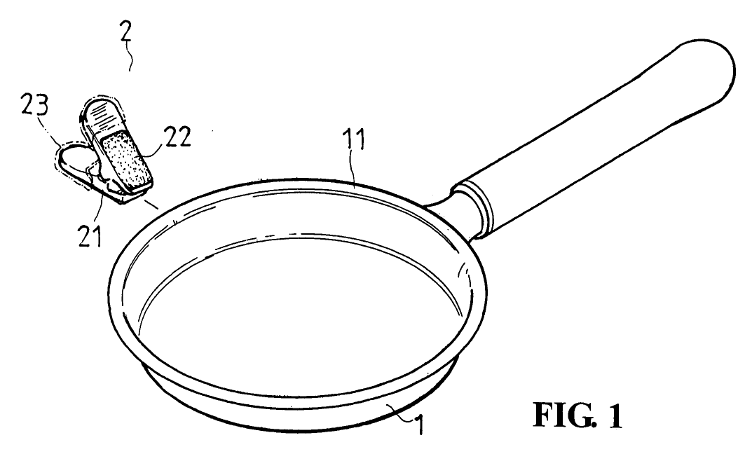

Referring to FIG. 1, there is shown an exploded perspective view of the temperature-sensing device in accordance with the present invention which comprises a clip 21 and a temperature-sensing element 22.

The clip 21 is a kind of fastener or the like and the material for fabricating of the clip 21 includes heat-conduction material. One clip face of the clip 21 is mounted with the temperature-sensing element 22 and the other end is a heat-insulation layer 23, which can isolate heat energy when the clip 21 is heated. This will prevent the user of the cooking pan from the heat-burning.

The temperature-sensing element 22 is a mechanism which can detect or sense the temperature and the sensing element 22 is clipped onto the clip 21.

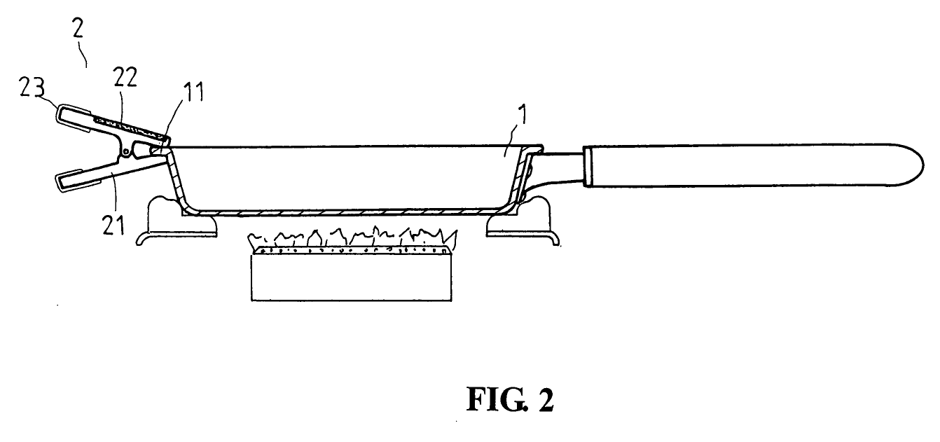

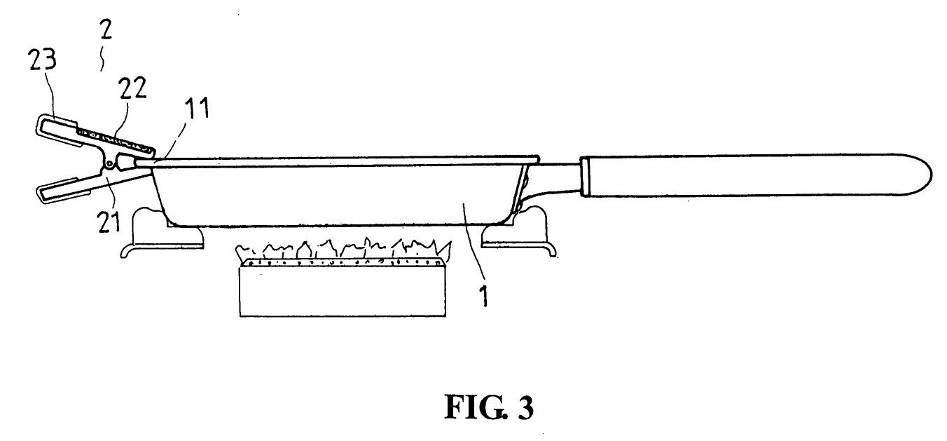

FIGS. 2 and 3 show the application of the temperature-sensing device on a cooking pan 1. The cooking pan 1 is placed over the stove and direct heating is applied to the cooking pan 1. The circumferential edge 11 of the cooking pan 1 corresponding to the position the heat energy transferred is mounted the pan clip 2. The clip 21 is directly contact with the circumferential edge 11 of the pan 11. Thus, the heat energy from the stove is transferred to the circumferential edge 11 and is then transferred to the clip 21. The material of the clip 21 is a temperature conductive material and the temperature-sensing element 22 will change to a specific color when the pan 1 is heated to a temperature. This will indicate to the user the temperature of the pan 1.

The mounting of the temperature-sensing element 22 can be liquid coating, solid state adhesion or mounted with an electronic temperature-detecting device. The component for the liquid coating includes material with temperature indication ranges, for instance, for A material, the temperature ranging is 50 degrees, for B material, the temperature range is 60 degree C., etc., and for an electronic temperature detecting device, the temperature is shown by LCD.

The advantages of the present invention includes:
1. the structure is simple and is a simple method to show the temperature of the pan;
2. the temperature-sensing element is provided at the clip to show temperature, and the clip onto the circumferential edge will not touch the food in the pan;
3. the clip can be used on any cooking pans or pots;
4. the clip can be unloaded when the cooking pan or pot is being cleaned; and
5. the mounting of the temperature-sensing element can be done by liquid coating, solid state adhesion or an electronic temperature detecting device; thus, the method of mounting the temperature-sensing element varies according to the needs of the product.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A temperature-sensing device for a cooking pan having a clip made from heat conductive material mounted onto the circumferential edge of the cooking pan, characterized in that one end of the clip fastened at the circumferential edge turns to a color when the pan body is heated, allowing a user to determine the temperature of the cooking pan.

2. The temperature-sensing device of claim 1, wherein one end of the clip is a temperature-sensing element and one end of the temperature-sensing element is a heat isolation layer to isolate heat from the clip to reach the user.

3. The temperature-sensing device of claim 1, wherein the clip is fastened to the circumferential edge of the cooking pan or pot.

4. The temperature-sensing device of claim 1, wherein the temperature-sensing element include a liquid temperature-sensing coating mounted by coating process and the components of the coating control the range of temperature.

5. The temperature-sensing device of claim 1, wherein the temperature-sensing element is a solid state adhesion mounted onto a clip.

6. The temperature-sensing device of claim 1, wherein the temperature-sensing electronic element and the detected temperature is shown by LCD.
